(19) United States
(12) Patent Application Publication
(10) Pub. No.: US 2008/0043090 A1
(43) Pub. Date: Feb. 21, 2008

(54) Systems and methods for optimizing video processing

(76) Inventor: Yair Wiener, Herzlia (IL)

Correspondence Address: WILMERHALE/NEW YORK, 399 PARK AVENUE, NEW YORK, NY, 10022, US

(21) Appl. No.: 11/500,137

(22) Filed: Aug. 7, 2006

(51) Int. Cl. H04N 7/14

(52) U.S. Cl. 348/14.09

(57) ABSTRACT

Systems and methods for constructing cost-efficient, low processing power continuous presence layouts are provided. In particular, new functionality to the H.264 Recommendation is added by providing an enhanced continuous presence feature.

### FIELD OF THE INVENTION

The present invention generally relates to video processing. More particularly, the present invention relates to systems and methods for optimizing video processing by creating video layouts from a set of video streams.

### BACKGROUND OF THE INVENTION

Videoconferencing systems allow multiple locations to interact via the simultaneous transmission of video and audio. Simultaneous videoconferencing among three or more locations is possible using a bridge, which is sometimes referred to as a Multipoint Conferencing Unit (MCU). The MCU is a bridge that interconnects calls from several sources. For example, the parties to a videoconference may call the MCU to connect to the videoconference. Some MCUs include software, while others include both software and hardware.

These MCUs include features such as continuous presence display. The continuous presence display feature allows the video of multiple parties to be seen on-screen simultaneously. However, continuous presence display is a feature that is processing intensive. For example, continuous presence display can be accomplished by using multiple decoders and multiple video displays at each site. In another example, continuous presence display can be accomplished by combining the individual video into a single video in a mosaic arrangement of several individual videos.

FIG. 1 illustrates an example of how continuous presence display is performed using conventional systems (e.g., the viaIP MCU manufactured by Radvision, the MXP MCU manufactured by Tandberg, the MCU manufactured by Polycom, and the MCU manufactured by Codian). For continuous presence display, the MCU receives all of the streams or video signals from each participant in the conference (step 110). In response, the MCU decodes all of the received streams using one or more decoders (step 120). Each stream is then scaled to a particular size based on the composed layout (step 130). For example, if there are four participants in the a videoconference, the MCU may create a 2×2 composed layout, where each stream is scaled to the size of a quadrant of the composed layout. The scaled streams are assembled and encoded again (step 140). In many systems, the MCU assembles different views of the scaled streams and encodes them for each participant. For example, the MCU encodes different views for different participants so that participants do not see themselves in the videoconference.

Accordingly, there exists a need for systems and methods for video processing that overcome these and other deficiencies in prior art systems.

### SUMMARY OF THE INVENTION

In accordance with some embodiments of the present invention, a method for video processing in a videoconference using a multipoint conferencing unit is provided. The multipoint conferencing unit opens an asymmetric channel for each endpoint participating in the videoconference. In response to receiving a self-confined H.264 video stream from each endpoint, wherein the self-confined H.264 video stream does not have out-of-frame boundary motion vectors, the multipoint conferencing unit transcodes the received self-confined H.264 video stream into flexible macroblock ordering slices. A first self-confined H.264 video stream received from a first endpoint is transcoded into a first flexible macroblock ordering slice and a second self-confined H.264 video stream received from a second endpoint is transcoded into a second flexible macroblock ordering slice. The multipoint conferencing unit then updates a picture parameter set header that is associated with each endpoint based at least in part on the endpoints participating in the videoconference. Outgoing video streams for each endpoint are generated based at least in part on the picture parameter header. A first outgoing video stream and a second outgoing video stream includes at least one of the first flexible macroblock ordering slice and the second flexible macroblock ordering slice. The first outgoing video stream is transmitted to the first endpoint and the second outgoing video stream is transmitted to the second endpoint.

In some embodiments, the received video stream is in Quarter Common Intermediate Format (QCIF).

In some embodiments, the first and second outgoing video stream are in Common Intermediate Format (CIF).

In some embodiments, the first outgoing video stream that is transmitted to the first endpoint includes the second flexible macroblock ordering slice associated with the second endpoint and the second outgoing video stream that is transmitted to the second endpoint includes the first flexible macroblock ordering slice associated with the first endpoint. For example, the present invention can support a “no self-see” feature, where the first endpoint receives a stream with the second flexible macroblock ordering slice that is associated with the second endpoint and not the slice associated with the first endpoint.

In some embodiments, the picture parameter set header that is associated with each endpoint is updated based on subframes required by that endpoint.

In some embodiments, when the received video stream conforms to the H.264 standard, the multipoint conferencing unit transcodes the received video stream to the self-confined H.264 video stream.

Thus, there has been outlined, rather broadly, the more important features of the invention in order that the detailed description thereof that follows may be better understood, and in order that the present contribution to the art may be better appreciated. There are, of course, additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and description matter in which there is illustrated preferred embodiments of the invention.

### BRIEF DESCRIPTION OF THE DRAWINGS

The above and other objects and advantages of the present invention will be apparent upon consideration of the following detailed description, taken in conjunction with the accompanying drawings, in which like reference characters refer to like parts throughout, and in which:

FIG. 1 is a flowchart illustrating the continuous presence feature in conventional multipoint conferencing units.

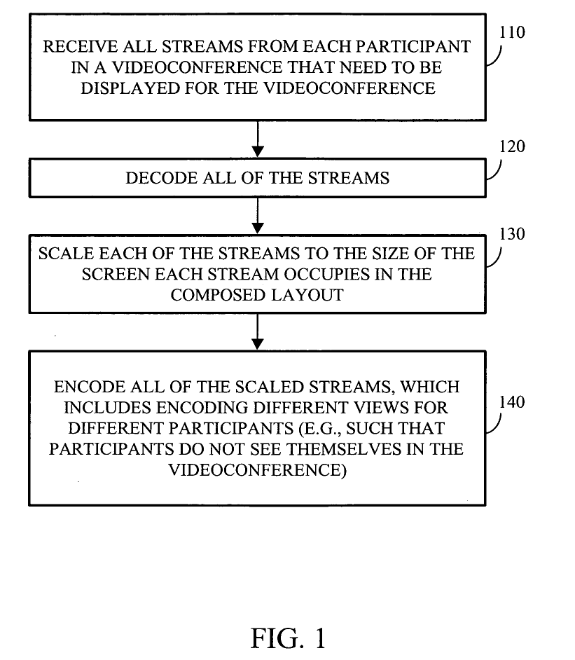

FIG. 2 illustrates an example of a composite layout in accordance with the ITU-T H.264 Recommendation.

FIG. 3 is a flowchart illustrating the continuous presence feature in accordance with some embodiments of the present invention.

FIG. 4 is a flowchart illustrative the continuous presence feature by transcoding an incoming H.264 stream or video signal in accordance with some embodiments of the present invention.

### DETAILED DESCRIPTION OF THE INVENTION

An illustrative video coding protocol that may be used with various embodiments disclosed herein are described, for example, in the ITU-T H.264 Recommendation, entitled “Advanced video coding for generic audiovisual services,” published March 2005 by the International Telecommunication Union-Telecommunication Standardization Sector, which is hereby incorporated by reference herein in its entirety.

In particular, the H.264 Recommendation provides a set of error resilience tools, such as the Flexible Macroblock Ordering (FMO) feature. Using Flexible Macroblock Ordering, each macroblock can be assigned freely to a certain slice group using a macroblock allocation map. The macroblock allocation map is encoded as part of the picture parameter set (PPS). As used herein, a “macroblock” is a 16×16 block of pixels that stores luminance and chrominance matrices. The macroblocks are grouped into any number of slice groups or slices.

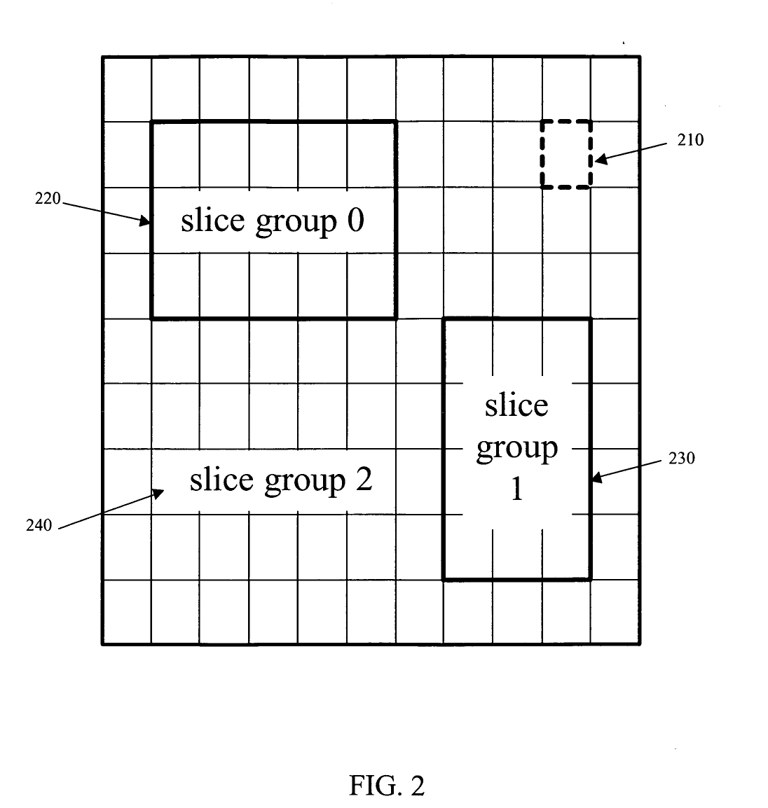

An illustrative example of macroblocks and slice groups in accordance with the H.264 Recommendation is shown in FIG. 2. Macroblocks, such as macroblock 210 may be organized into slices or slice groups (e.g., slice groups 220, 230, and 240). In the example of FIG. 2, macroblock allocation maps maybe stored using the top left and bottom right coordinates of each rectangular slice group.

In accordance with the present invention, as an alternative to the H.264 Recommendation, an enhanced continuous presence feature is provided.

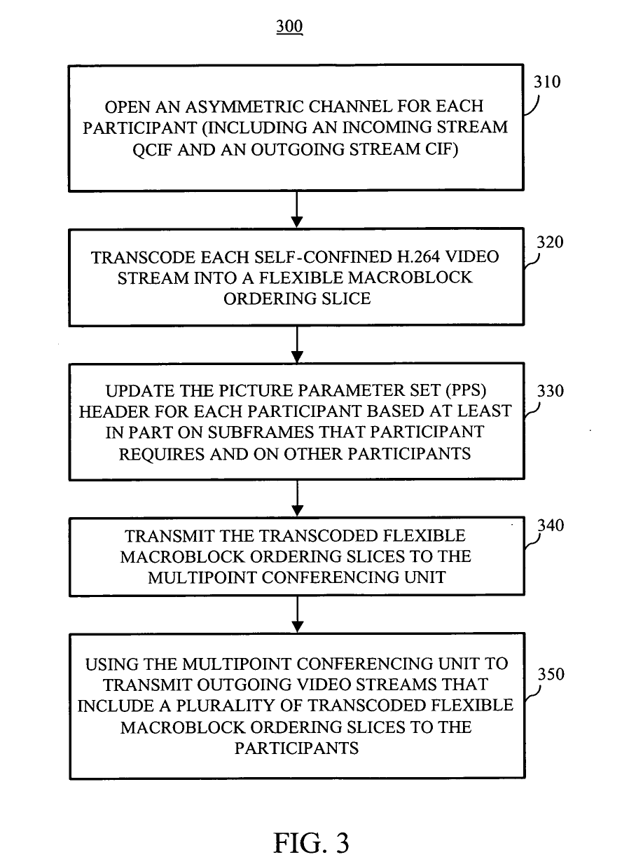

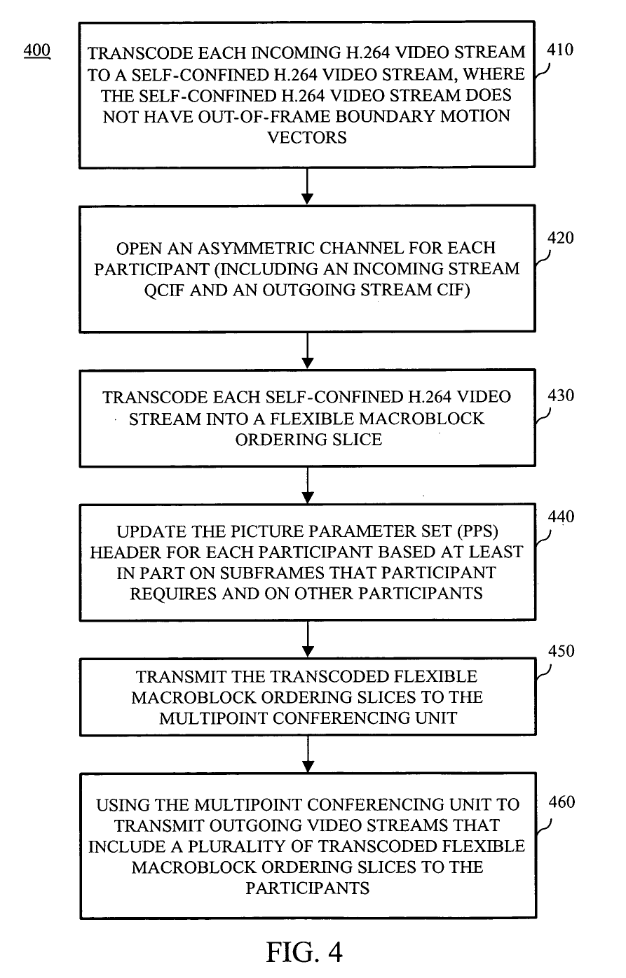

Turning to FIGS. 3 and 4, simplified flowcharts illustrating the steps performed in providing a continuous presence feature in accordance with some embodiments of the present invention. These are generalized flow charts. It will be understood that the steps shown in FIGS. 3 and 4 may be performed in any suitable order, some may be deleted, and others added.

Generally, process 300 begins by providing endpoint devices. Each endpoint device is capable of encoding a self-confined H.264 video stream. As used herein, a self-confined H.264 video stream is a stream or signal that does not have out-of-frame boundary motion vectors. Endpoint devices provide streams or signals to the multipoint conferencing unit (MCU). The MCU may transmit multiple signals to each of the endpoint devices. It should be noted that the MCU and the endpoint devices may be implemented as hardware devices or as a combination of hardware and software.

As shown in FIG. 3, process 300 begins by opening an asymmetric channel for each participant in a videoconference (step 310). Each of the endpoint devices for each participant may generate a video stream having a Quarter Common Intermediate Format (QCIF). As shown in the following steps, the incoming QCIF frames of the video stream are manipulated by the MCU to form one or more outgoing video streams. Each outgoing video stream may include one or more Common Intermediate Format (CIF) frames.

At step 320, the MCU transcodes each self-confined H.264 video stream from each endpoint into a slice. In some embodiments, the slice or slice group is assigned using the H.264 Recommendation. At step 330, the picture parameter set (PPS) header is updated for each participant of the videoconference based at least in part on the subframes that the participant requires and on the other participants. As used herein, a picture parameter set (PPS) is a syntax structure containing syntax elements that apply to zero or more entire coded pictures as determined by the pic_parameter_set_id syntax element found in each slice header. A slice header is generally a part of a coded slice containing the data elements pertaining to the first or all macroblocks represented in the slice.

For example, the incoming QCIF subframes may be manipulated by the MCU and the MCU may then update the PPS header so that the user sees the video streams of the other participant, but not that participant himself or herself. In another example, the MCU may update the PPS header such that the user sees all participants of the videoconference including himself or herself.

At step 340, the transcoded flexible macroblock ordering slices are transmitted to the logic of the multipoint conferencing unit, where different streams (each with different slices) are generated and provided to each endpoint. For example, for a videoconference having four participants, four different streams with different slices are generated for each user at an endpoint.

For example, a “no self see” feature may be included in some embodiments. The “no self see” feature provides the user of a multipoint conferencing unit with the ability to see all the other participants in a videoconference and avoid seeing himself or herself. In accordance with the “no self see” feature, the MCU may generate different streams for each endpoint.

At step 350, the MCU may transmit outgoing video streams that include one or more transcoded flexible macroblock ordering slices to the endpoints of the participants. For example, if there are three participants in a videoconference, the MCU may transmit an outgoing video stream that includes all of the slices associated with each of the participants. In another example, the MCU may transmit an outgoing video stream to a first endpoint that includes the slices associated with the participants except for the slice associated with the first endpoint.

In some embodiments, the present invention may be used with any standard H.264 codec. It should be noted that the H.264 Recommendation includes seven sets of capabilities that target specific classes of applications, which are sometimes referred to herein as profiles. It should also be noted that flexible macroblock ordering is a required feature only in H.264 baseline profile. FIG. 4 is a simplified flowchart illustrating the steps performed in providing a continuous presence feature in accordance with some embodiments of the present invention. It should be noted that although FIG. 4 and the following embodiments of the present invention generally relate to providing an enhanced continuous presence feature using the H.264 Recommendation, these embodiments are not limited only to using H.264. Rather, the invention may also be applied to any suitable codec.

Generally, process 400 begins by providing endpoint devices. Each endpoint device transmits an H.264 video stream or signal to an MCU. At step 410, the MCU transcodes each incoming H.264 video stream into a self-confined H.264 video stream. A self-confined H.264 video stream is generally a stream or signal that does not have out-of-frame boundary motion vectors. In some embodiments, the transcoding may be distributed and performed on different blades and support up to eight subframes.

At step 420, and as described previously in step 310, an asymmetric channel for each participant in a videoconference is opened. Each of the endpoint devices for each participant may generate a video stream having a Quarter Common Intermediate Format (QCIF). As shown in the following steps, the incoming QCIF frames of the video stream are manipulated by the MCU to form one or more outgoing video streams. Each outgoing video stream may include one or more Common Intermediate Format (CIF) frames.

At step 430, and as described previously in step 320, the MCU transcodes each self-confined H.264 video stream from each endpoint into a slice. In some embodiments, the slice or slice group is assigned using the H.264 Recommendation. At step 440, the picture parameter set (PPS) header is updated for each participant of the videoconference based at least in part on the subframes that the participant requires and on the other participants. As used herein, a picture parameter set (PPS) is a syntax structure containing syntax elements that apply to zero or more entire coded pictures as determined by the pic_parameter_set_id syntax element found in each slice header. A slice header is generally a part of a coded slice containing the data elements pertaining to the first or all macroblocks represented in the slice.

For example, the incoming QCIF subframes may be manipulated by the MCU and the MCU may then update the PPS header so that the user sees the video streams of the other participant, but not that participant himself or herself. In another example, the MCU may update the PPS header such that the user sees all participants of the videoconference including himself or herself.

At step 450, and as described previously in step 340, the transcoded flexible macroblock ordering slices are transmitted to the logic of the multipoint conferencing unit, where different streams (each with different slices) are generated and provided to each endpoint. For example, for a videoconference having four participants, four different streams with different slices are generated for each user at an endpoint.

For example, a “no self see” feature may be included in some embodiments. The “no self see” feature provides the user of a multipoint conferencing unit with the ability to see all the other participants in a videoconference and avoid seeing himself or herself. In accordance with the “no self see” feature, the MCU may generate different streams for each endpoint.

At step 460, as described previously in step 350, the MCU may transmit outgoing video streams that include one or more transcoded flexible macroblock ordering slices to the endpoints of the participants. For example, if there are three participants in a videoconference, the MCU may transmit an outgoing video stream that includes all of the slices associated with each of the participants. In another example, the MCU may transmit an outgoing video stream to a first endpoint that includes the slices associated with the participants except for the slice associated with the first endpoint.

Using process 300 of FIG. 3 or process 400 of 4 provides a more efficient approach for layout creation, which can increase density and lower costs of videoconferencing systems generating layouts that combine multiple video streams.

In accordance with the present invention, systems and methods for providing an enhanced continuous presence feature are provided.

It will also be understood that the detailed description herein may be presented in terms of program procedures executed on a computer (e.g., an endpoint) or network of computers. These procedural descriptions and representations are the means used by those skilled in the art to most effectively convey the substance of their work to others skilled in the art.

A procedure is here, and generally, conceived to be a self-consistent sequence of steps leading to a desired result. These steps are those requiring physical manipulations of physical quantities. Usually, though not necessarily, these quantities take the form of electrical or magnetic signals capable of being stored, transferred, combined, compared and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to these quantities.

Further, the manipulations performed are often referred to in terms, such as adding or comparing, which are commonly associated with mental operations performed by a human operator. No such capability of a human operator is necessary, or desirable in most cases, in any of the operations described herein which form part of the present invention; the operations are machine operations. Useful machines for performing the operation of the present invention include general purpose digital computers or similar devices.

The present invention also relates to apparatus for performing these operations. This apparatus may be specially constructed for the required purpose or it may comprise a general purpose computer as selectively activated or reconfigured by a computer program stored in the computer. The procedures presented herein are not inherently related to a particular computer or other apparatus. Various general purpose machines may be used with programs written in accordance with the teachings herein, or it may prove more convenient to construct more specialized apparatus to perform the required method steps. The required structure for a variety of these machines will appear from the description given.

The system according to the invention may include a general purpose computer, or a specially programmed special purpose computer. The user may interact with the system via e.g., a personal computer or over PDA, e.g., the Internet an Intranet, etc. Either of these may be implemented as a distributed computer system rather than a single computer. Similarly, the communications link may be a dedicated link, a modem over a POTS line, the Internet and/or any other method of communicating between computers and/or users. Moreover, the processing could be controlled by a software program on one or more computer systems or processors, or could even be partially or wholly implemented in hardware.

Although a single computer (e.g., an endpoint) may be used, the system according to one or more embodiments of the invention is optionally suitably equipped with a multitude or combination of processors or storage devices. For example, the computer may be replaced by, or combined with, any suitable processing system operative in accordance with the concepts of embodiments of the present invention, including sophisticated calculators, hand held, laptop/notebook, mini, mainframe and super computers, as well as processing system network combinations of the same. Further, portions of the system may be provided in any appropriate electronic format, including, for example, provided over a communication line as electronic signals, provided on CD and/or DVD, provided on optical disk memory, etc.

Any presently available or future developed computer software language and/or hardware components can be employed in such embodiments of the present invention. For example, at least some of the functionality mentioned above could be implemented using Visual Basic, C, C++ or any assembly language appropriate in view of the processor being used. It could also be written in an object oriented and/or interpretive environment such as Java and transported to multiple destinations to various users.

It is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Although the present invention has been described and illustrated in the foregoing exemplary embodiments, it is understood that the present disclosure has been made only by way of example, and that numerous changes in the details of implementation of the invention may be made without departing from the spirit and scope of the invention, which is limited only by the claims which follow.

What is claimed is:

1. A method for video processing in a videoconference using a multipoint conferencing unit, the method comprising:
opening an asymmetric channel for each endpoint participating in the video conference;
receiving a self-confined H.264 video stream from each endpoint, wherein the self-confined H.264 video stream does not have out-of-frame boundary motion vectors;
transcoding the received self-confined H.264 video stream into flexible macroblock ordering slices, wherein a first self-confined H.264 video stream received from a first endpoint is transcoded into a first flexible macroblock ordering slice and a second self-confined H.264 video stream received from a second endpoint is transcoded into a second flexible macroblock ordering slice;
updating a picture parameter set header for each endpoint based at least in part on the endpoints participating in the videoconference;
generating outgoing video streams for each endpoint based at least in part on the picture parameter set header, wherein a first outgoing video stream includes at least one of the first flexible macroblock ordering slice and the second flexible macroblock ordering slice and a second outgoing video stream includes at least one of the first flexible macroblock ordering slice the second flexible macroblock ordering slice; and
transmitting the first outgoing video stream to the first endpoint and the second outgoing video stream to the second endpoint.

2. The method of claim 1, wherein the received video stream is in Quarter Common Intermediate Format (QCIF).

3. The method of claim 1, wherein the first and second outgoing video stream are in Common Intermediate Format (CIF).

4. The method of claim 1, wherein the first outgoing video stream that is transmitted to the first endpoint includes the second flexible macroblock ordering slice associated with the second endpoint and wherein the second outgoing video stream that is transmitted to the second endpoint includes the first flexible macroblock ordering slice associated with the first endpoint.

5. The method of claim 1, wherein the picture parameter set header associated with each endpoint is updated based on subframes required by that endpoint.

6. The method of claim 1, further comprising:
receiving a video stream that conforms to the H.264 standard; and
transcoding the video stream to the self-confined H.264 video stream.

7. A system for video processing in a videoconference involving multiple endpoints, the system comprising:
a multipoint conferencing unit that is configured to:
open an asymmetric channel for each of the multiple endpoints participating in the videoconference;
receive a self-confined H.264 video stream from each of the multiple endpoints, wherein the self-confined H.264 video stream does not have out-of-frame boundary motion vectors;
transcode the received self-confined H.264 video stream into flexible macroblock ordering slices, wherein a first self-confined H.264 video stream received from a first endpoint is transcoded into a first flexible macroblock ordering slice and a second self-confined H.264 video stream received from a second endpoint is transcoded into a second flexible macroblock ordering slice;
update a picture parameter set header associated with each of the multiple endpoints based at least in part on the endpoints participating in the videoconference;
generate outgoing video streams for each endpoint based at least in part on the picture parameter set header, wherein a first outgoing video stream includes at least one of the first flexible macroblock ordering slice and the second flexible macroblock ordering slice and a second outgoing video stream includes at least one of the first flexible macroblock ordering slice the second flexible macroblock ordering slice; and
transmit the first outgoing video stream to the first endpoint and the second outgoing video stream to the second endpoint.

8. The system of claim 7, wherein the received video stream is in Quarter Common Intermediate Format (QCIF).

9. The system of claim 7, wherein the first and second outgoing video stream are in Common Intermediate Format (CIF).

10. The system of claim 7, wherein the first outgoing video stream that is transmitted to the first endpoint includes the second flexible macroblock ordering slice associated with the second endpoint and wherein the second outgoing video stream that is transmitted to the second endpoint includes the first flexible macroblock ordering slice associated with the first endpoint.

11. The system of claim 7, wherein the multipoint conferencing unit is further configured to update the picture parameter set header associated with each endpoint based on subframes required by that endpoint.

12. The system of claim 7, wherein the multipoint conferencing unit is further configured to:
receive a video stream that conforms to the H.264 standard; and
transcode the video stream to the self-confined H.264 video stream.
